(19) United States
(12) Patent Application Publication
(10) Pub. No.: US 2025/0315396 A1
(43) Pub. Date: Oct. 9, 2025

(54) COMMUNICATION APPARATUS, STATE CONTROL METHOD, AND NON-TRANSITORY RECORDING MEDIUM

(71) Applicant: Shu Yanai, KANAGAWA (JP)

(72) Inventor: Shu Yanai, KANAGAWA (JP)

(73) Assignee: Ricoh Company, Ltd., Tokyo (JP)

(21) Appl. No.: 19/086,731

(22) Filed: Mar. 21, 2025

(30) Foreign Application Priority Data
Apr. 8, 2024 (JP) 2024-062159

(51) Int. Cl. G06F 13/38; G06F 13/42

(52) U.S. Cl. CPC G06F 13/382; G06F 13/4282; G06F 2213/0042

(57) ABSTRACT

A communication apparatus includes: a USB device including a USB interface to enable communication between the communication apparatus and another apparatus, and a USB device controller to manage an operation state of the USB device; and circuitry to manage a power supply state of the communication apparatus; and perform a state control process of controlling the communication apparatus to transition to a power supply state with lower power consumption than a current power supply state, when an operation state in which the USB device stops communication with said another apparatus has continued for a predetermined period of time.

### CROSS-REFERENCE TO RELATED APPLICATIONS

This patent application is based on and claims priority pursuant to 35 U.S.C. § 119(a) to Japanese Patent Application No. 2024-062159, filed on Apr. 8, 2024, in the Japan Patent Office, the entire disclosure of which is hereby incorporated by reference herein.

### BACKGROUND

### Technical Field

The present disclosure relates to a communication apparatus, a state control method, and a non-transitory recording medium.

### Related Art

Some apparatuses monitor a network port in a power-saving mode. When a network is disconnected for a certain period, the apparatuses turn off the main power supply to reduce power consumption.

The usability for users decreases if a communication cable is accidentally unplugged and the power supply is consequently turned off. To avoid this inconvenience, some techniques determine connection and disconnection of communication with a counterpart device, based on the power supply in a physical layer.

### SUMMARY

According to an embodiment, a communication apparatus includes a USB device and circuitry. The USB device includes a USB interface and a USB device controller. The USB interface enables communication between the communication apparatus and another apparatus. The USB device controller manages an operation state of the USB device. The circuitry manages a power supply state of the communication apparatus. The circuitry performs a state control process of controlling the communication apparatus to transition to a power supply state with lower power consumption than a current power supply state when an operation state in which the USB device stops communication with said another apparatus has continued for a predetermined period of time.

According to an embodiment, a state control method performed by a communication apparatus including a USB device. The USB device includes a USB interface. The USB interface enables communication between the communication apparatus and another apparatus. The state control method includes managing an operation state of the USB device, managing a power supply state of the communication apparatus, and performing a state control process of controlling the communication apparatus to transition to a power supply state with lower power consumption than a current power supply state when an operation state in which the USB device stops communication with said another apparatus has continued for a predetermined period of time.

According to an embodiment, a non-transitory recording medium stores a plurality of instructions which, when executed by one or more processors on a communication apparatus, causes the one or more processors to perform a state control method, the communication apparatus including a USB device. The USB device includes a USB interface. The USB interface enables communication between the communication apparatus and another apparatus. The state control method includes managing an operation state of the USB device, managing a power supply state of the communication apparatus, and performing a state control process of controlling the communication apparatus to transition to a power supply state with lower power consumption than a current power supply state when an operation state in which the USB device stops communication with said another apparatus has continued for a predetermined period of time.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of a communication system;

FIG. 2 is a diagram illustrating an example of a functional configuration of a communication apparatus;

FIG. 3 is a diagram for describing an example of a layer configuration in Universal Serial Bus (USB) communication;

FIG. 4 is a diagram for describing an example of functional layers of a USB device;

FIG. 5 is a diagram illustrating an example of a state transition in a communication apparatus according to a first embodiment;

FIG. 6 is a diagram illustrating an example of a state transition in a USB device according to the first embodiment;

FIG. 7 is a diagram for describing an example of a transition process to a suspended state;

FIG. 8 is a diagram for describing an example of the transition process to the suspended state;

FIG. 9 is a flowchart illustrating an example of a state control process according to the first embodiment;

FIG. 10 is a diagram illustrating an example of a state transition in a communication apparatus according to a second embodiment;

FIG. 11 is a diagram illustrating an example of a state transition in a USB device according to the second embodiment;

FIG. 12 is a first flowchart illustrating an example of a state control process according to the second embodiment; and

FIG. 13 is a second flowchart illustrating an example of the state control process according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described in detail below with reference to the drawings.

### System Configuration

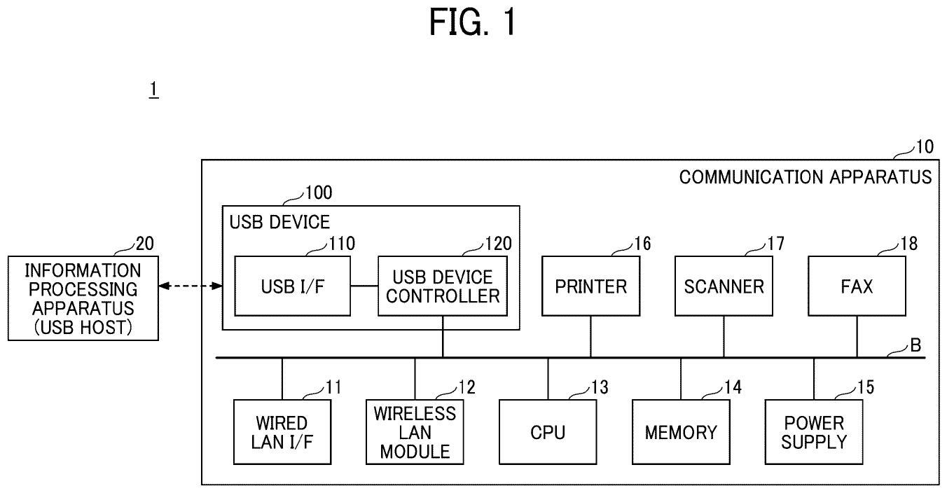

FIG. 1 is a diagram illustrating an example of a configuration of a communication system. A communication system 1 includes a communication apparatus 10 including a Universal Serial Bus (USB) device 100 including a USB interface (I/F) 110. The communication apparatus 10 communicates with another apparatus having a USB host function via the USB I/F 110.

FIG. 1 illustrates an example of a hardware configuration of the communication apparatus 10, which is an image forming apparatus including functions of a printer, a scanner, a copier, and a facsimile machine (FAX), for example. The communication apparatus 10 may be an electronic device having a function of the USB device 100, other than the image forming apparatus. For example, the communication apparatus 10 may be an output device such as a projector (PJ), an interactive whiteboard (IWB) which is a whiteboard having an electronic whiteboard function and a capability of mutual communication, or a digital signage, or a head-up display (HUD) device, for example. The communication apparatus 10 may be industrial machinery, an image-capturing device, a sound collector, medical equipment, a smart appliance, or an automobile (connected car), for example. The communication apparatus 10 may be a notebook personal computer (PC), a mobile phone, a smartphone, a tablet terminal, a game machine, a personal digital assistant (PDA), a digital camera, a wearable PC, or a desktop PC, for example.

An information processing apparatus 20 is, for example, a computer having a function of the USB host such as a PC, a tablet terminal, or a smartphone. The information processing apparatus 20 is an example of another apparatus to communicate with a communication apparatus, and may be an external apparatus of the communication system 1. Hardware Configuration

In the example in FIG. 1, the communication apparatus 10 includes a wired local area network (LAN) I/F 11, a wireless LAN module 12, a central processing unit (CPU) 13, a memory 14, a power supply 15, a printer 16, a scanner 17, a FAX 18, the USB device 100, and a bus B.

The wired LAN I/F 11 is a communication interface that connects the communication apparatus 10 to a network with a communication cable such as a LAN cable. The wireless LAN module 12 is a communication interface that connects the communication apparatus 10 to a network by wireless communication.

The CPU 13 is, for example, a processor (processing device) that executes a predetermined program stored in a storage medium such as the memory 14 to control the entire communication apparatus 10. The memory 14 includes, for example, a random access memory (RAM) and a read-only memory (ROM). The RAM is a volatile memory to be used as a work area for the CPU 13. The ROM is a nonvolatile memory in which a booting program is stored in advance. The memory 14 may include, for example, a storage device such as a hard disk drive (HDD) or a solid state drive (SSD).

The power supply 15 is a power supply circuit or power supply system that supplies each components of the communication apparatus 10 with electric power. The printer 16 is a device that performs a printing process. The scanner 17 is a device that performs a document reading process. The FAX 18 is a device that performs a fax transmission/reception process. For example, when the communication apparatus 10 is a projector, the communication apparatus 10 includes an image projecting device that performs an image projection process, instead of the printer 16, the scanner 17, and the FAX 18.

The USB device 100 includes, for example, the USB I/F 110 and a USB device controller 120. The USB I/F 110 transmits and receives data to and from another communication apparatus by USB communication. The USB device controller 120 controls USB communication performed via the USB I/F 110. The bus B is connected to the components described above, and transfers an address signal, a data signal, and various control signals, for example.

### Functional Configuration

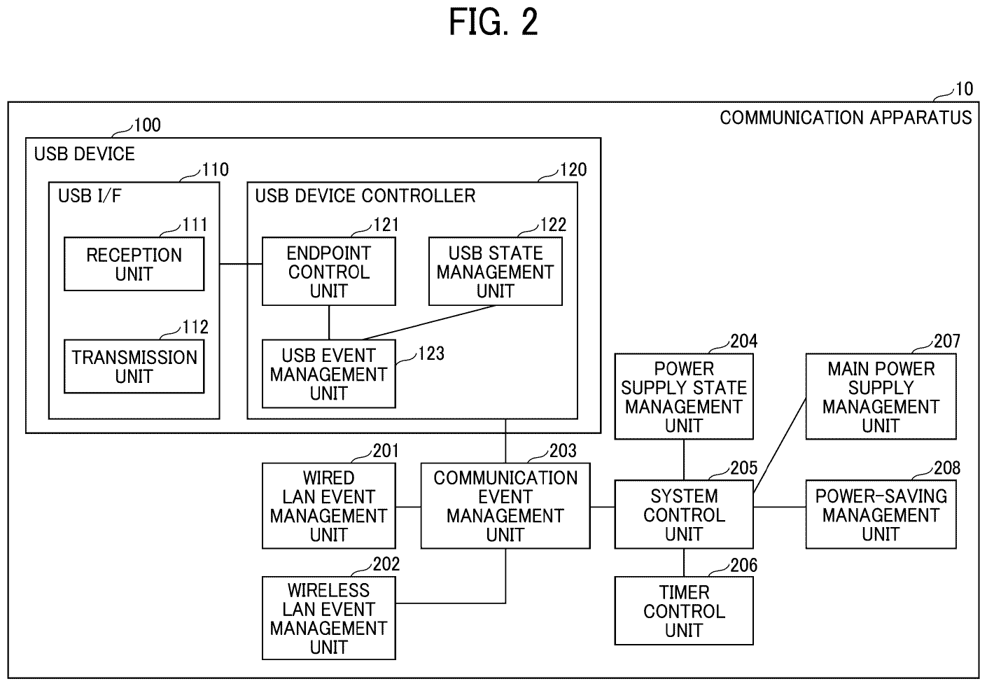

FIG. 2 is a diagram illustrating an example of a functional configuration of the communication apparatus.

### Functional Configuration of USB Device

The USB I/F 110 of the USB device 100 includes, for example, a reception unit 111 and a transmission unit 112. The reception unit 111 performs a reception process of receiving data from another apparatus that serves as a USB host (i.e., the information processing apparatus 20). The transmission unit 112 performs a transmission process of transmitting data to another apparatus that serves as a USB host, under control of the USB device controller 120.

The USB device controller 120 has a configuration of a computer, for example. The USB device controller 120 executes a predetermined program to implement functional components such as an endpoint control unit 121, a USB state management unit 122, and a USB event management unit 123. At least one of the functional components mentioned above may be implemented by hardware.

The endpoint control unit 121 controls input/output of data to/from an endpoint, which is a first-in first-out (FIFO) buffer that stores data subjected to USB communication. The endpoint control unit 121 acquires information on the USB I/F 110 (e.g., a connection state of a USB cable).

The USB state management unit 122 manages an operation state of the USB device 100. Examples of the operation state of the USB device 100 include a cable-detached state, an attached state, a powered state, a default state, an address state, a configured state, a suspended state, and a pause state. The operation states and the state transition will be described below.

The USB event management unit 123 receives USB information from the endpoint control unit 121 and the USB state management unit 122, and notifies a communication event management unit 203 of the USB information. The USB event management unit 123 receives a notification of an automatic transition off state (described later) from the communication event management unit 203, and notifies the USB state management unit 122 of the automatic transition off state.

### Functional Configuration of Communication Apparatus

For example, the communication apparatus 10 executes a predetermined program stored in a storage medium such as the memory 14 to implement functional components such as a wired LAN event management unit 201, a wireless LAN event management unit 202, the communication event management unit 203, a power supply state management unit 204, a system control unit 205, a timer control unit 206, a main power supply management unit 207, and a power-saving management unit 208. At least one of the functional components mentioned above may be implemented by hardware.

The wired LAN event management unit 201 detects an event such as connection or disconnection of a network to or from the wired LAN I/F 11, and notifies the communication event management unit 203 of the event. The wireless LAN event management unit 202 detects an event such as connection or disconnection of a network to or from the wireless LAN module 12, and notifies the communication event management unit 203 of the event.

The communication event management unit 203 manages information on communication events which the communication event management unit 203 is notified of by the USB event management unit 123, the wired LAN event management unit 201, and the wireless LAN event management unit 202. For example, the communication event management unit 203 manages USB information including the operation state of the USB device 100 and a connection state of a USB cable or the like, which the communication event management unit 203 is notified of by the USB event management unit 123. The communication event management unit 203 manages connection states of communication ports, which the communication event management unit 203 is notified of by the wired LAN event management unit 201 and the wireless LAN event management unit 202.

The power supply state management unit 204 performs a power supply state management process of managing the power supply state of the communication apparatus 10. Examples of the power supply state of the communication apparatus 10 include a normal state, a power-saving state, a main power off state, and an automatic transition off state. The normal state is a power supply state in which the communication apparatus 10 is normally activated and a predetermined function (e.g., printing, scan, copy, or fax) of the communication apparatus 10 is executable. The power-saving state (first power-saving state) is a power supply state in which part of hardware of the communication apparatus 10 is stopped and the power consumption is lower than in the normal state. In the power-saving state, the communication apparatus 10 may be disabled to perform the predetermined function mentioned above.

The main power off state is a power supply state in which the communication apparatus 10 is completely powered off. For example, to return the communication apparatus 10 from the main power off state to the normal state, a main power supply button is to be pressed. The automatic transition off state (second power-saving state) is a power supply state in which the power consumption is lower than in the power-saving state, the most part of the communication apparatus 10 is stopped, and the minimum functionality is operating. The automatic transition off state transitions to the power-saving state in response to detection of insertion of a communication cable such as a USB cable or a LAN cable. The automatic transition off state transitions to the normal state in response to pressing of the main power supply button. Note that the automatic transition off state is optional and is not mandatory.

The system control unit 205 is a control unit that controls the entire communication apparatus 10. For example, the system control unit 205 performs a state control process of controlling the communication apparatus 10 to transition to a power supply state with lower power consumption than a current power supply state when an operation state in which the USB device 100 stops communication with another apparatus has continued for a predetermined period. The “current power supply state” is a power supply state in which the state control process is started.

Preferably, the system control unit 205 performs the state control process in the case where a cable is connected to the USB I/F 110, the current power supply state is the power-saving state, or a communication interface of the wireless LAN or the wired LAN is disabled, for example.

The timer control unit 206 controls a timer that measures the predetermined period. The main power supply management unit 207 performs a process of powering on or off the entire communication apparatus 10. The power-saving management unit 208 performs a process of causing the communication apparatus 10 to transition to a state such as the normal state, the power-saving state, the main power off state, or the automatic transition off state.

Note that the functional configuration of the communication apparatus 10 illustrated in FIG. 2 is an example. For example, the system control unit 205 may have at least part of the functions of the communication event management unit 203, the power supply state management unit 204, the timer control unit 206, the main power supply management unit 207, and the power-saving management unit 208.

### Layer Configuration of USB Communication

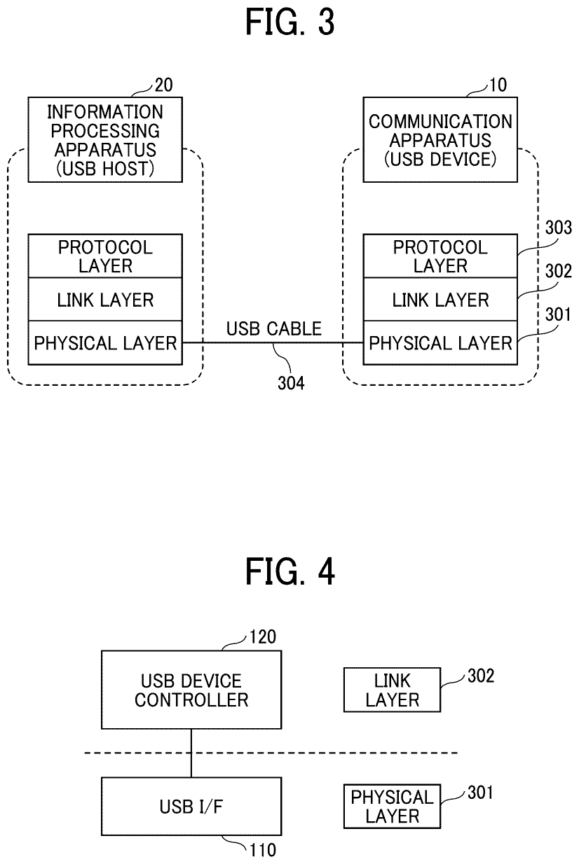

FIG. 3 is a diagram for describing an example of a layer configuration in USB communication. The communication apparatus (USB device) 10 has a layer configuration including a physical layer 301, a link layer 302, and a protocol layer 303. The information processing apparatus (USB host) 20 has substantially the same layer configuration.

The physical layer 301 transmits and receives data in a form of electric signals via a USB cable 304. The link layer 302 controls communication between neighboring devices (e.g., the USB host and the USB device). The protocol layer 303 performs packet control.

FIG. 4 is a diagram for describing an example of functional layers of the USB device. As illustrated in FIG. 4, the USB I/F 110 corresponds to the physical layer 301. The USB device controller 120 corresponds to the link layer 302.

### First Embodiment

### State Transition in Communication Device

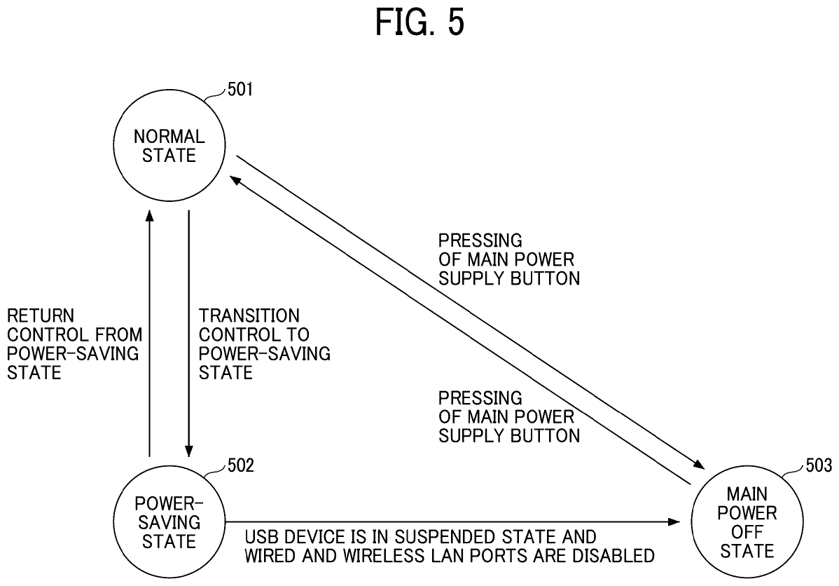

FIG. 5 is a diagram illustrating an example of the state transition in the communication apparatus according to a first embodiment. The communication apparatus 10 according to the first embodiment has three power supply states, i.e., a normal state 501, a power-saving state 502, and a main power off state 503.

The normal state 501 is a power supply state in which the communication apparatus 10 is normally activated and a predetermined function of the communication apparatus 10 is executable. The communication apparatus 10 transitions to the power-saving state 502 in response to transition control to the power-saving state 502 in the normal state 501. The communication apparatus 10 transitions to the main power off state 503 in response to pressing of the main power supply button in the normal state 501.

The power-saving state 502 is a power supply state in which part of hardware of the communication apparatus 10 is stopped and the power consumption is lower than in the normal state 501. The communication apparatus 10 transitions to the normal state 501 in response to return control from the power-saving state 502 in the power-saving state 502. The communication apparatus 10 transitions to the main power off state 503 in the case where the USB device 100 is in the suspended state and the wired LAN port and the wireless LAN port are disabled in the power-saving state 502.

The main power off state 503 is a power supply state in which the communication apparatus 10 is completely powered off. The communication apparatus 10 transitions to the normal state 501 in response to pressing of the main power supply button in the main power off state 503.

### State Transition in USB Device

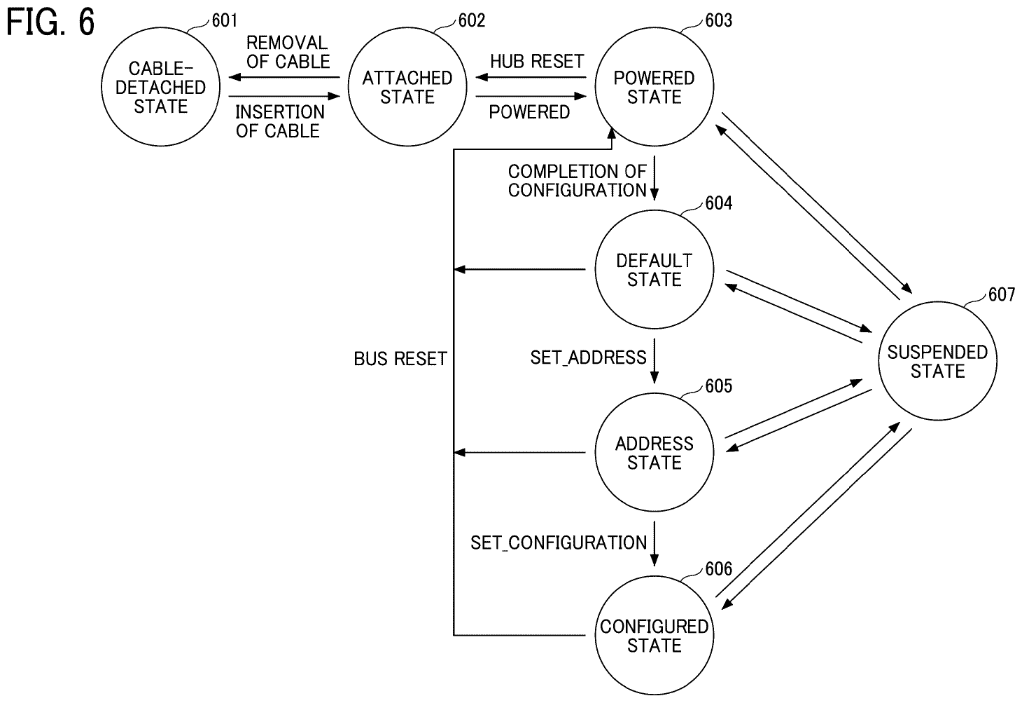

FIG. 6 is a diagram illustrating an example of a state transition in the USB device according to the first embodiment. The USB device 100 has operation states such as a cable-detached state 601, an attached state 602, a powered state 603, a default state 604, an address state 605, a configured state 606, and a suspended state 607.

The cable-detached state 601 is an operation state in which a cable is not connected to the USB I/F 110. The USB device 100 transitions from the cable-detached state 601 to the attached state 602 in response to insertion of a cable to the USB I/F 110 in the cable-detached state 601. The attached state 602 is a state in which a cable is connected to the USB I/F 110 but the USB device 100 is not powered. The USB device 100 transitions from the attached state 602 to the powered state 603 in response to being powered in the attached state 602. The USB device 100 transitions from the attached state 602 to the cable-detached state 601 in response to removal of the cable from the USB I/F 110 in the attached state 602. The USB device 100 transitions from the powered state 603 to the attached state 602 in response to an instruction to reset the hub.

The powered state 603 is a state in which the cable is connected to the USB I/F 110 and the USB device 100 is powered but is not ready for communication. The USB device 100 transitions from the powered state 603 to the default state 604 in response to the completion of the configuration in the powered state 603. The default state 604 is a state in which the cable is connected to the USB I/F 110 and the USB device 100 is powered and ready for communication but is not assigned an address. The USB device 100 transitions from the default state 604 to the address state 605 in response to a SET_ADDRESS command in the default state 604. The USB device 100 transitions from the default state 604 to the powered state 603 in response to bus reset.

The address state 605 is a state in which the cable is connected to the USB I/F 110 and the USB device 100 is powered, is ready for communication, and has been assigned an address but is not configured (not ready for use). The USB device 100 transitions from the address state 605 to the configured state (ready-for-use state) 606 in response to a SET CONFIGURATION command in the address state 605. The USB device 100 transitions from the address state 605 to the powered state 603 in response to bus reset. The configured state 606 is a state in which the USB device 100 is powered, is ready for communication, and has been assigned an address and configured. The USB device 100 transitions from the configured state 606 to the powered state 603 in response to bus reset in the configured state 606.

The suspended state 607 is a state in which the USB device 100 and the bus are at low power. The USB device 100 transitions to the suspended state 607 from any one of the powered state 603, the default state 604, the address state 605, and the configured state 606.

According to the USB 2.0, the USB device 100 transitions to the suspended state 607 in response to detection of no bus activity for 3 ms or longer in the powered state 603, the default state 604, the address state 605, or the configured state 606.

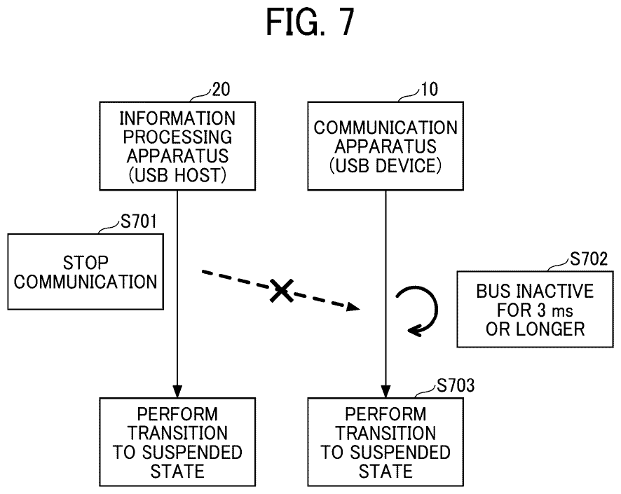

FIG. 7 is a diagram illustrating an example of a transition process to the suspended state (in the case of USB 2.0). For example, in step S701, the information processing apparatus 20 stops communication during the communication with the communication apparatus 10. In this case, the USB state management unit 122 of the communication apparatus 10 detects a bus inactive state for 3 ms or longer in step S702, and then causes the USB device 100 to transition to the suspended state 607 in step S703. In the USB 2.0, the condition under which the suspended state 607 is canceled is the bus being active.

In the USB 3.0, the USB device 100 transitions to the suspended state 607 in response to a request for transition to the suspended state 607 from the USB host.

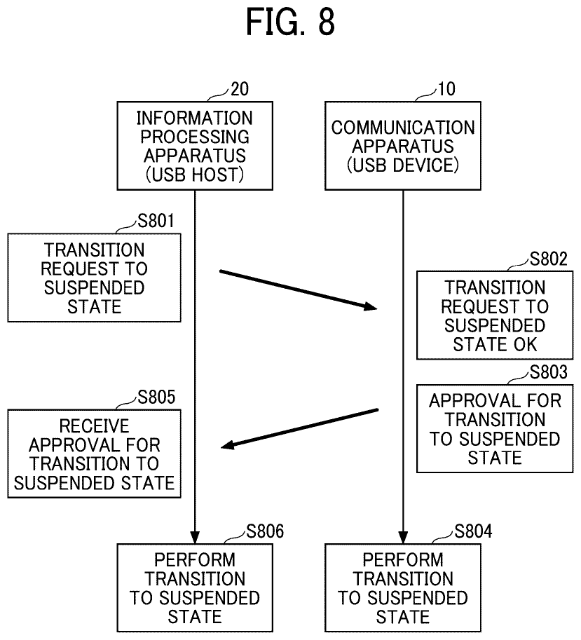

FIG. 8 is a diagram illustrating an example of a transition process to a suspended state (in the case of USB 3.0). For example, in step S801, the information processing apparatus 20 outputs a transition request to the suspended state.

In this case, in step S802, the USB state management unit 122 of the communication apparatus 10 returns OK for the transition request to the suspended state. The USB state management unit 122 returns an approval for transition to the suspended state, to the information processing apparatus 20 in step S803, and performs transition to the suspended state in step S804.

The information processing apparatus 20 receives the approval for transition to the suspended state in step S805, and performs transition to the suspended state in step S806.

### Process Flow

A process flow of a state control method according to the first embodiment will be described.

### State Control Process

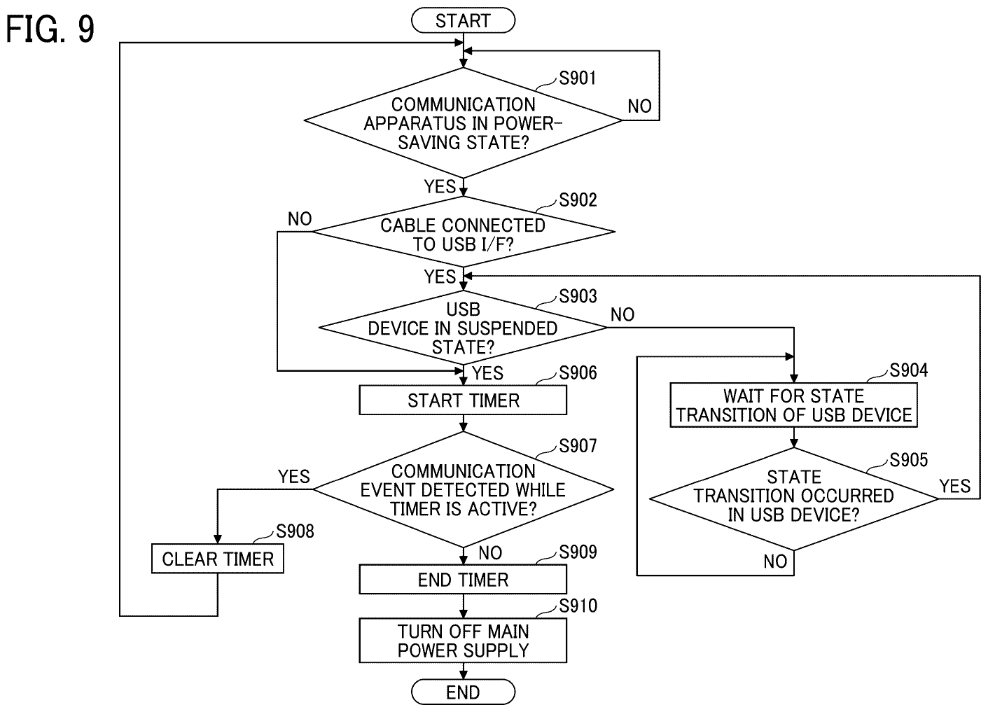

FIG. 9 is a flowchart illustrating an example of a state control process according to the first embodiment. This process presents an example of the state control process performed by the communication apparatus 10 having the functional configuration illustrated in FIG. 2.

In step S901, the system control unit 205 determines whether the power supply state of the communication apparatus 10 managed by the power supply state management unit 204 is the power-saving state 502. When the communication apparatus 10 is in the power-saving state 502, the system control unit 205 causes the process to proceed to step S902. On the other hand, when the communication apparatus 10 is not in the power-saving state 502, the system control unit 205 performs the processing of step S901 again.

After the process proceeds to step S902, the system control unit 205 determines whether a cable is connected to the USB I/F 110, based on the USB information managed by the communication event management unit 203. As described above, the communication event management unit 203 manages the USB information including the operation state of the USB device 100 and the connection state of a cable such as a USB cable, which the communication event management unit 203 is notified of by the USB event management unit 123.

When a cable is connected to the USB I/F 110, the system control unit 205 causes the process to proceed to step S903. On the other hand, when a cable is not connected to the USB I/F 110, the system control unit 205 causes the process to proceed to step $906.

After the process proceeds to step S903, the system control unit 205 determines whether the operation state of the USB device 100 is the suspended state (the suspended state 607), based on the USB information managed by the communication event management unit 203. That is, the system control unit 205 determines whether the USB device 100 is in an operation state in which communication with another apparatus is stopped. When the USB device 100 is in the suspended state, the system control unit 205 causes the process to proceed to step S906. On the other hand, the USB device 100 is not in the suspended state, the system control unit 205 causes the process to proceed to step S904.

In step S904, the system control unit 205 waits for the transition of the state of the USB device 100. In step S905, the system control unit 205 returns the process to step S903 after the transition of the state of the USB device 100. As described above, the USB event management unit 123 receives the USB information from the endpoint control unit 121 and the USB state management unit 122, and notifies the communication event management unit 203 of the USB information. Thus, the system control unit 205 acquires the USB information managed by the communication event management unit 203 at predetermined intervals, for example, and thus determines whether the transition of the state of the USB device 100 has occurred.

After the process proceeds to step S906, the system control unit 205 starts a timer by using the timer control unit 206. That is, the system control unit 205 starts measuring the time for which the suspended state (the suspended state 607) has continued in the USB device 100.

According to the revised Energy-related Products (ErP) Lot 6 (energy efficiency standard), which is the regulations in Europe, the main power supply is to be turned off when the network is disconnected for a predetermined period. The system control unit 205 starts measuring time by using the timer described above, to measure this predetermined period of time. The predetermined period of time is, for example, 20 minutes, but may be set in accordance with a period determined based on the regulations.

In step S907, the system control unit 205 determines whether a communication event is detected while the timer is active, based on information on the communication event managed by the communication event management unit 203. As described above, the communication event management unit 203 manages the information on the communication events which the communication event management unit 203 is notified of by the USB event management unit 123, the wired LAN event management unit 201, and the wireless LAN event management unit 202.

When a communication event is detected while the timer is active, the system control unit 205 causes the process to proceed to step S908. On the other hand, when no communication event is detected while the timer is active, the system control unit 205 causes the process to proceed to step S909.

After the process proceeds to step S908, the system control unit 205 clears (initializes) the timer in measurement by using the timer control unit 206, and returns the process to step S901. On the other hand, after the process proceeds to step S909, the system control unit 205 ends the timer in measurement by using the timer control unit 206.

In step S910, the system control unit 205 performs control to turn off the main power supply of the communication apparatus 10. For example, the system control unit 205 instructs the main power supply management unit 207 to turn off the main power supply. That is, when the timer has measured the time which indicates continuation of the suspended state (the suspended state 607) of the USB device 100 for the predetermined period of time, the transition is performed from the power-saving state, which is the current power supply state of the communication apparatus 10, to the power supply state of the main power supply off with lower power consumption.

The process illustrated in FIG. 9 can reduce the power consumption of the communication apparatus 10 when communication is not performed, in the communication apparatus 10 that communicates with another apparatus (i.e., the information processing apparatus 20) via the USB interface.

### Second Embodiment

### State Transition in Communication Device

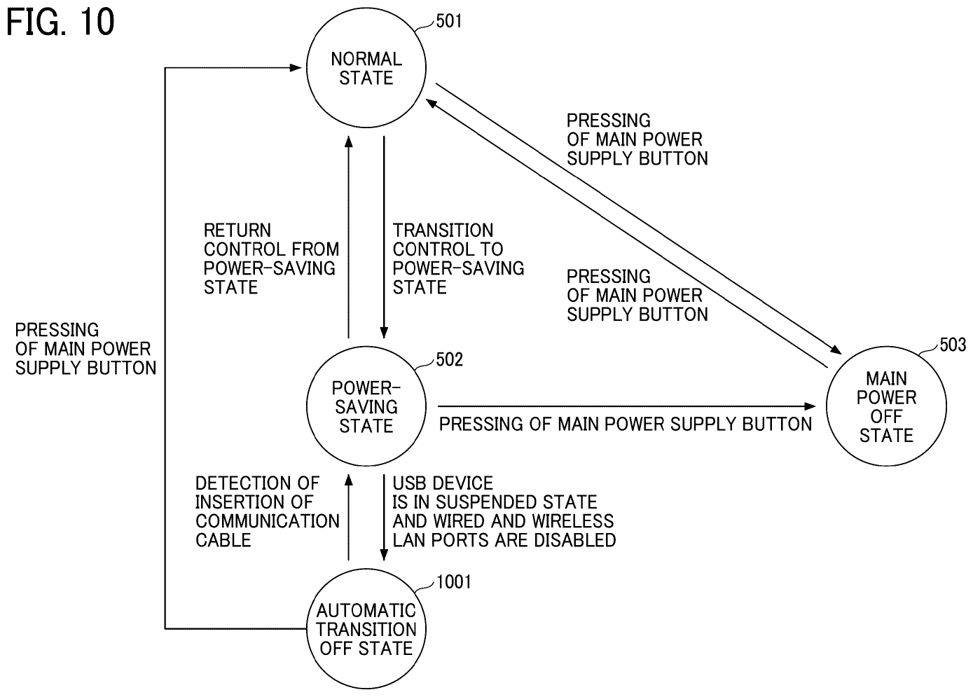

FIG. 10 is a diagram illustrating an example of a state transition in a communication apparatus according to a second embodiment. The communication apparatus 10 has an automatic transition off state 1001 in addition to the normal state 501, the power-saving state 502, and the main power off state 503.

The normal state 501 is a power supply state in which the communication apparatus 10 is normally activated and a predetermined function of the communication apparatus 10 is executable. The communication apparatus 10 transitions to the power-saving state 502 in response to transition control to the power-saving state 502 in the normal state 501. The communication apparatus 10 transitions to the main power off state 503 in response to pressing of the main power supply button in the normal state 501.

The power-saving state (first power-saving state) 502 is a power supply state in which part of hardware of the communication apparatus 10 is stopped and the power consumption is lower than in the normal state 501. The power-saving state 502 is an example of a first power-saving state with lower power consumption than the normal state 501 in which a normal operation is allowed.

The communication apparatus 10 transitions to the normal state 501 in response to return control from the power-saving state 502 in the power-saving state 502. The communication apparatus 10 transitions to the main power off state 503 when the main power supply button is pressed. The communication apparatus 10 transitions to the automatic transition off state 1001 when the USB device 100 is in the suspended state and the wired LAN port and the wireless LAN port are disabled.

The main power off state 503 is a power supply state in which the communication apparatus 10 is completely powered off. The communication apparatus 10 transitions to the normal state 501 in response to pressing of the main power supply button in the main power off state 503.

The automatic transition off state (second power-saving state) 1001 is an off state to which the state transition is automatically made without pressing of the main power supply button or the like. The automatic transition off state 1001 is a state in which the power consumption is lower than in the power-saving state 502, the most part of the communication apparatus 10 is stopped, and the minimum functionality is operating. The automatic transition off state 1001 is an example of a second power-saving state, with lower power consumption than the first power-saving state, in which the connection state of a cable to the communication apparatus 10 is detectable.

The communication apparatus 10 transitions to the power-saving state 502 when insertion of a communication cable such as a wireless LAN cable or a USB cable is detected in the automatic transition off state 1001. The communication apparatus 10 transitions to the normal state 501 when the main power supply button is pressed in the automatic transition off state 1001.

### State Transition in USB Device

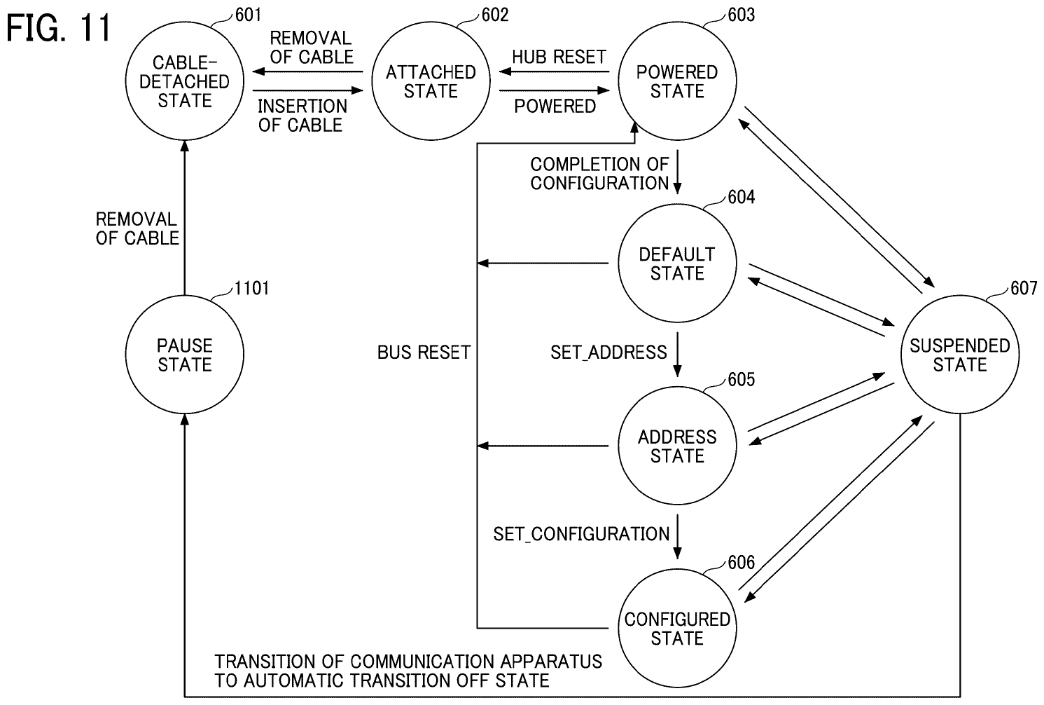

FIG. 11 is a diagram illustrating an example of a state transition in the USB device according to the second embodiment. The operation states of the USB device 100 include a pause state 1101 in addition to the cable-detached state 601, the attached state 602, the powered state 603, the default state 604, the address state 605, the configured state 606, and the suspended state 607.

The cable-detached state 601, the attached state 602, the powered state 603, the default state 604, the address state 605, the configured state 606, and the suspended state 607 are substantially the same as the respective operation states described in FIG. 6.

The USB device 100 transitions to the pause state 1101 in the case where the communication apparatus 10 has transitioned to the automatic transition off state 1001 described in FIG. 10 while the USB device 100 is in the suspended state 607.

In the pause state 1101, functions other than a function of detecting removal of a cable are set off and the bus stops communication. Thus, from the viewpoint of the USB host (the information processing apparatus 20), the pause state 1101 is a disconnected state. The power consumption is lower in the pause state 1101 than in the suspended state 607. The USB device 100 transitions to the cable-detached state 601 in response to detection of removal of the cable in the pause state 1101.

The pause state 1101 is provided for the purpose below. If the communication apparatus 10 transitions to the automatic transition off state 1001 with the state transition of the USB device 100 according to the first embodiment being kept unchanged, the operation state of the USB device 100 is the cable-detached state 601. However, the cable is actually connected at this time. This causes a mismatch in the operation state of the USB device 100. Accordingly, in the second embodiment, the pause state 1101 in which the USB cable is connected but the USB device 100 is not performing communication is newly defined to solve the mismatch in the operation state of the USB device 100.

### Process Flow

A process flow of a state control method according to the second embodiment will be described.

### State Control Process

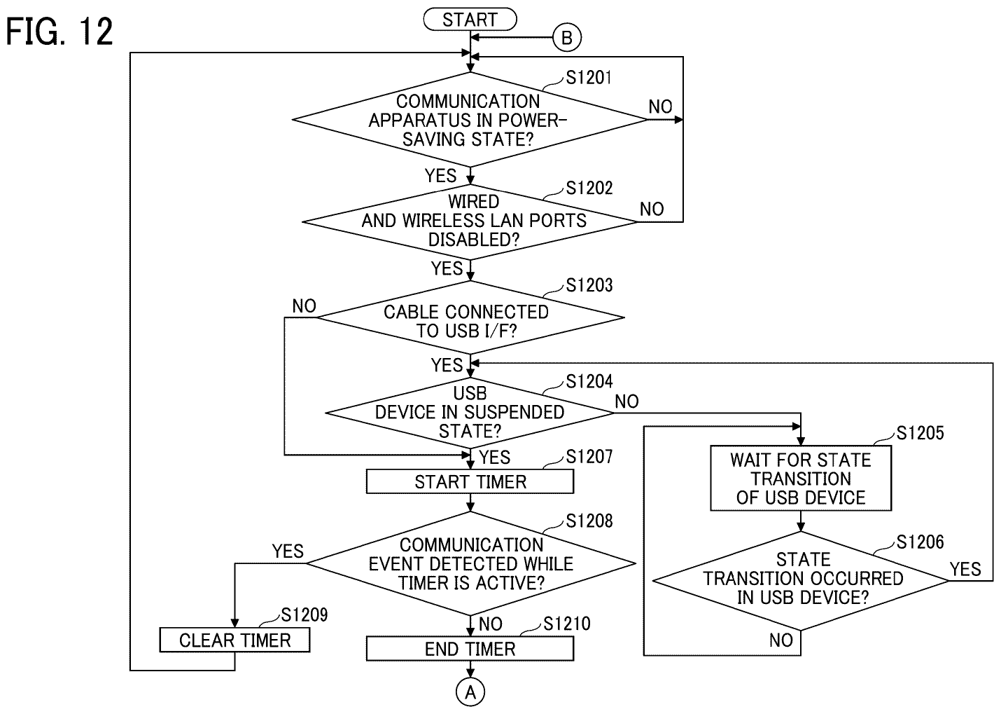

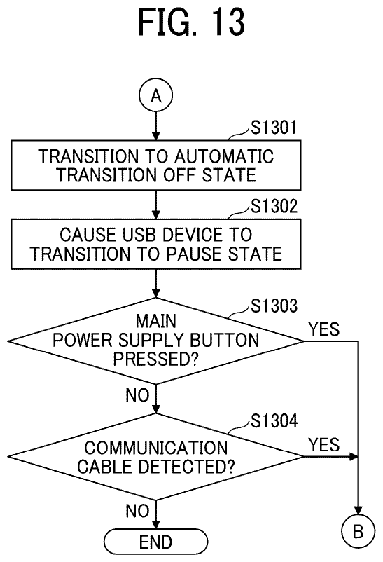

FIGS. 12 and 13 are flowcharts illustrating an example of a state control process according to the second embodiment. This process presents another example of the state control process to be performed by the communication apparatus 10 having the functional configuration illustrated in FIG. 2. Note that the detailed description of the processing content that is substantially the same as that of the state control process according to the first embodiment described with reference to FIG. 9 is omitted.

In step S1201, the system control unit 205 determines whether the power supply state of the communication apparatus 10 managed by the power supply state management unit 204 is the power-saving state 502 (i.e., the first power-saving state). When the communication apparatus 10 is in the power-saving state 502, the system control unit 205 causes the process to proceed to step S1202. On the other hand, when the communication apparatus 10 is not in the power-saving state 502, the system control unit 205 performs the processing of step S1201 again.

After the process proceeds to step S1202, the system control unit 205 determines whether the wired LAN port and the wireless LAN port are disabled, based on the connection states of the communication ports managed by the communication event management unit 203. As described above, the communication event management unit 203 manages the connection states of the communication ports, which the communication event management unit 203 is notified of by the wired LAN event management unit 201 and the wireless LAN event management unit 202. When the wired LAN port and the wireless LAN port are disabled, the system control unit 205 causes the process to proceed to step S1203. On the other hand, when the wired LAN port and the wireless LAN port are not disabled, the system control unit 205 causes the process to proceed to step S1201.

After the process proceeds to step S1203, the system control unit 205 determines whether a cable is connected to the USB I/F 110, based on the USB information managed by the communication event management unit 203. When a cable is connected to the USB I/F 110, the system control unit 205 causes the process to proceed to step S1204. On the other hand, when a cable is not connected to the USB I/F 110, the system control unit 205 causes the process to proceed to step S1207.

After the process proceeds to step S1204, the system control unit 205 determines whether the operation state of the USB device 100 is the suspended state (the suspended state 607), based on the USB information managed by the communication event management unit 203. That is, the system control unit 205 determines whether the USB device 100 is in an operation state in which communication with another apparatus is stopped. When the USB device 100 is in the suspended state, the system control unit 205 causes the process to proceed to step S1207. On the other hand, the USB device 100 is not in the suspended state, the system control unit 205 causes the process to proceed to step S1205.

In step S1205, the system control unit 205 waits for the transition of the state of the USB device 100. In step S1206, the system control unit 205 returns the process to step S1204 after the transition of the state of the USB device 100.

After the process proceeds to step S1207, the system control unit 205 starts a timer by using the timer control unit 206. That is, the system control unit 205 starts measuring the time for which the suspended state (the suspended state 607) has continued in the USB device 100.

In step S1208, the system control unit 205 determines whether a communication event is detected while the timer is active, based on the information on the communication event managed by the communication event management unit 203. When a communication event is detected while the timer is active, the system control unit 205 causes the process to proceed to step S1209. On the other hand, when no communication event is detected while the timer is active, the system control unit 205 causes the process to proceed to step S1210. After the process proceeds to step S1209, the system control unit 205 clears (initializes) the timer in measurement by using the timer control unit 206, and returns the process to step S1201. On the other hand, after the process proceeds to step S1210, the system control unit 205 ends the timer in measurement by using the timer control unit 206, and performs processing illustrated in FIG. 13.

In step S1301 in FIG. 13, the system control unit 205 causes the power supply state of the communication apparatus 10 to transition to the automatic transition off state 1001. That is, when the timer has measured the time which indicates continuation of the suspended state (the suspended state 607) of the USB device 100 for the predetermined period of time, the transition is performed from the power-saving state, which is the current power supply state of the communication apparatus 10, to the power supply state of the automatic transition off state with lower power consumption.

The system control unit 205 notifies, for example, the power supply state management unit 204 and the communication event management unit 203 of upcoming transition to the automatic transition off state 1001, and then instructs the power-saving management unit 208 to transition to the automatic transition off state 1001.

In step S1302, the USB device 100 transitions to the pause state (the pause state 1101). For example, in response to being notified of transition to the automatic transition off state 1001 by the communication event management unit 203, the USB event management unit 123 causes the operation state of the USB device 100 to the pause state.

In step S1303, the system control unit 205 determines whether the main power supply button of the communication apparatus 10 is pressed. When the main power supply button is not pressed, the system control unit 205 causes the process to proceed to step S1304. On the other hand, the main power supply button is pressed, the system control unit 205 returns the process to step S1201 in FIG. 12.

After the process proceeds to step S1304, the system control unit 205 determines whether a communication cable (USB cable or LAN cable) is detected, based on the information on the communication event managed by the communication event management unit 203. As described above, the communication event management unit 203 manages the connection state of the USB cable and the connection state of the communication port which the communication event management unit 203 is notified of by the USB event management unit 123 and the wired LAN event management unit 201, respectively.

When a communication cable is detected, the system control unit 205 returns the process to step S1201 in FIG. 12. On the other hand, when no communication cable is detected, the system control unit 205 ends the process illustrated in FIGS. 12 and 13 (maintains the automatic transition off state 1001).

The process illustrated in FIGS. 12 and 13 allows the communication apparatus 10 to automatically transition from the automatic transition off state 1001, which is a low power consumption state like the main power off state 503, to the power-saving state 502 in response to detection of a communication cable without pressing of the main power supply button.

The first embodiment above describes the flow in which the state control process is performed in the case where the communication apparatus is in the power-saving state (YES in step S901 and a cable is connected to the USB I/F (YES in step S902). However, the state control process may be performed in the case where one of the states has occurred or none of the states have occurred.

The first embodiment above describes the main power off state as the power supply state with lower power consumption than the current power supply state (power-saving state). However, the current power supply state may transition to a power supply state in which the power consumption is higher than in the main power off state but is lower than in the power-saving state.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

A communication apparatus, a state control method, and a program below are disclosed herein.

According to Aspect 1, a communication apparatus includes a USB device, a USB state management unit, a power supply state management unit, and a system control unit. The USB device includes a USB interface. The communication apparatus communicates with another apparatus via the USB interface. The USB state management unit manages an operation state of the USB device. The power supply state management unit manages a power supply state of the communication apparatus. The system control unit performs a state control process of controlling the communication apparatus to transition to a power supply state with lower power consumption than a current power supply state when an operation state in which the USB device stops communication with said another apparatus has continued for a predetermined period of time.

According to Aspect 2, in the communication apparatus of Aspect 1, the system control unit performs the state control process in a case where the current power supply state is a power-saving state with lower power consumption than a normal state in which a normal operation is allowed.

According to Aspect 3, in the communication apparatus of Aspect 1 or 2, the system control unit performs the state control process in a case where a cable is connected to the USB interface.

According to Aspect 4, in the communication apparatus of any one of Aspects 1 to 3, the power supply state with lower power consumption than the current power supply state includes a power off state.

According to Aspect 5, the communication apparatus of any one of Aspects 1 to 3 further includes a communication interface different from the USB interface. The system control unit performs the state control process in a case where the communication interface is disabled.

According to Aspect 6, in the communication apparatus of Aspect 5, the power supply state with lower power consumption than the current power supply state includes a power supply state in which a function of returning to the current power supply state in response to connection of a cable to the USB interface or the communication interface is enabled.

According to Aspect 7, in the communication apparatus of Aspect 5 or 6, the power supply state with lower power consumption than the current power supply state includes a power supply state in which a function of detecting removal of a cable connected to the USB interface is enabled.

According to Aspect 8, in the communication apparatus of Aspect 1, the power supply state of the communication apparatus includes a first power-saving state with lower power consumption than a normal state in which a normal operation is allowed, and a second power-saving state with lower power consumption than the first power-saving state, the second power-saving state being a state in which a connection state of a cable to the communication apparatus is detectable. The system control unit causes the communication apparatus to transition to the second power-saving state when the operation state in which the USB device stops communication with said another apparatus has continued for the predetermined period of time in the first power-saving state.

According to Aspect 9, a state control method is to be executed by a communication apparatus. The communication apparatus includes a USB device including a USB interface and communicates with another apparatus via the USB interface. The state control method includes managing an operation state of the USB device, managing a power supply state of the communication apparatus, and performing a state control process of controlling the communication apparatus to transition to a power supply state with lower power consumption than a current power supply state when an operation state in which the USB device stops communication with said another apparatus has continued for a predetermined period of time.

According to Aspect 10, a program causes a communication apparatus to execute a state control method. The communication apparatus includes a USB device including a USB interface, and communicates with another apparatus via the USB interface. The state control method includes managing an operation state of the USB device, managing a power supply state of the communication apparatus, and performing a state control process of controlling the communication apparatus to transition to a power supply state with lower power consumption than a current power supply state when an operation state in which the USB device stops communication with said another apparatus has continued for a predetermined period of time.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A communication apparatus comprising:
a USB device including:
a USB interface to enable communication between the communication apparatus and another apparatus; and
a USB device controller to manage an operation state of the USB device; and
circuitry configured to:
manage a power supply state of the communication apparatus; and
perform a state control process of controlling the communication apparatus to transition to a power supply state with lower power consumption than a current power supply state, when an operation state in which the USB device stops communication with said another apparatus has continued for a predetermined period of time.

2. The communication apparatus according to claim 1, wherein the circuitry is configured to perform the state control process in a case where the current power supply state is a power-saving state with lower power consumption than a normal state in which the communication apparatus performs a normal operation.

3. The communication apparatus according to claim 2, wherein the circuitry is configured to perform the state control process in a case where a cable is connected to the USB interface.

4. The communication apparatus according to claim 1, wherein the power supply state with lower power consumption than the current power supply state includes a power off state.

5. The communication apparatus according to claim 1, further comprising:
a communication interface different from the USB interface, wherein
the circuitry is configured to perform the state control process in a case where the communication interface is disabled.

6. The communication apparatus according to claim 5, wherein the power supply state with lower power consumption than the current power supply state includes a power supply state in which a function of returning to the current power supply state in response to connection of a cable to the USB interface or the communication interface is enabled.

7. The communication apparatus according to claim 5, wherein the power supply state with lower power consumption than the current power supply state includes a power supply state in which a function of detecting removal of a cable connected to the USB interface is enabled.

8. The communication apparatus according to claim 1, wherein
the power supply state of the communication apparatus includes
a first power-saving state with lower power consumption than a normal state in which the communication apparatus performs a normal operation, and
a second power-saving state with lower power consumption than the first power-saving state, the second power-saving state being a state in which a connection state of a cable to the communication apparatus is detectable, and
the circuitry is configured to cause the communication apparatus to transition to the second power-saving state when the operation state in which the USB device stops communication with said another apparatus has continued for the predetermined period of time in the first power-saving state.

9. A state control method performed by a communication apparatus including a USB device, the USB device including a USB interface to enable communication between the communication apparatus and another apparatus, the state control method comprising:
managing an operation state of the USB device;
managing a power supply state of the communication apparatus; and
performing a state control process of controlling the communication apparatus to transition to a power supply state with lower power consumption than a current power supply state, when an operation state in which the USB device stops communication with said another apparatus has continued for a predetermined period of time.

10. The state control method according to claim 9, wherein the state control process is performed in a case where the current power supply state is a power-saving state with lower power consumption than a normal state in which the communication apparatus performs a normal operation.

11. The state control method according to claim 10, wherein the state control process is performed in a case where a cable is connected to the USB interface.

12. The state control method according to claim 9, wherein the power supply state with lower power consumption than the current power supply state includes a power off state.

13. The state control method according to claim 9, wherein the state control process is performed in a case where a communication interface different from the USB interface is disabled.

14. The state control method according to claim 13, wherein the power supply state with lower power consumption than the current power supply state includes a power supply state in which a function of returning to the current power supply state in response to connection of a cable to the USB interface or the communication interface is enabled.

15. The state control method according to claim 13, wherein the power supply state with lower power consumption than the current power supply state includes a power supply state in which a function of detecting removal of a cable connected to the USB interface is enabled.

16. The state control method according to claim 9, wherein
the power supply state of the communication apparatus includes
a first power-saving state with lower power consumption than a normal state in which the communication apparatus performs a normal operation, and
a second power-saving state with lower power consumption than the first power-saving state, the second power-saving state being a state in which a connection state of a cable to the communication apparatus is detectable, and
the method further comprises causing the communication apparatus to transition to the second power-saving state when the operation state in which the USB device stops communication with said another apparatus has continued for the predetermined period of time in the first power-saving state.

17. A non-transitory recording medium storing a plurality of instructions which, when executed by one or more processors on a communication apparatus, causes the one or more processors to perform a state control method, the communication apparatus including a USB device, the USB device including a USB interface to enable communication between the communication apparatus and another apparatus, the state control method comprising:
managing an operation state of the USB device;
managing a power supply state of the communication apparatus; and
performing a state control process of controlling the communication apparatus to transition to a power supply state with lower power consumption than a current power supply state, when an operation state in which the USB device stops communication with said another apparatus has continued for a predetermined period of time.
